(19) United States
(12) Patent Application Publication
(10) Pub. No.: US 2017/0160827 A1
(43) Pub. Date: Jun. 8, 2017

(54) TOUCH SENSOR, TOUCH PANEL, AND ELECTRONIC DEVICE

(71) Applicant: SMK Corporation, Tokyo (JP)

(72) Inventor: Takayuki NAKASE, Toyama (JP)

(21) Appl. No.: 15/187,799

(22) Filed: Jun. 21, 2016

(30) Foreign Application Priority Data
Dec. 3, 2015 (JP) 2015-236424

(51) Int. Cl. G06F 3/041

(52) U.S. Cl. CPC G06F 3/041

(57) ABSTRACT

An object of the present invention is to allow the front end of a connector tail to be naturally inserted into a connector, for example. A touch sensor includes: a sensor unit; and a connector tail having a first end portion connected to the sensor unit and a second end portion connected to a connector formed on a control substrate disposed on the back side of the sensor unit. The second end portion of the connector tail includes a correction portion inclined according to an inclination angle formed by the sensor unit and the control substrate.

### CROSS REFERENCE TO RELATED APPLICATION

The contents of the following Japanese patent application are incorporated herein by reference,

Japanese Patent Application No. 2015-236424 filed on Dec. 3, 2015.

### FIELD

The present invention relates to a touch sensor, a touch panel, and an electronic device.

### BACKGROUND

In recent years, there have been widely prevalent touch panels (also called touch screens) with touch sensors disposed for detecting operation inputs on display elements such as liquid crystal display elements or the like included in mobile terminals, cellular phones, car navigation systems, and others. In addition, there have also been proposed curved touch panels with curved input areas called 2.5D, 3D, or the like. For example, WO No. 2014/045562 describes a touch panel with a curved touch sensor that detects an input position based on changes in the capacitance of an electrode.

### SUMMARY

In general, a touch sensor is connected to a flat plate-like conductor (hereinafter, called connector tail as appropriate) for extracting signals to the outside. The connector tail is also called flexible tail, lead wire, tail conductor, tail, or the like. The connector tail is folded at an angle of about 180 degrees, for example, and its front end is connected to a connector on a printed wired board (PWB) on the back side of the touch sensor. The connector tail is generally configured such that, when being folded, its portion mounted on the touch sensor and its portion connected to the connector are approximately parallel to each other.

As described in WO No. 2014/045562, when the touch sensor has a curved shape, the connector tail connected to the touch sensor is also deformed in a curve. In this state, when the connector tail is folded, the portion of the connector tail connected to the connector inclines, and it becomes difficult to insert naturally the front end of the connector tail into the connector. In addition, when the touch panel device is assembled while the connector tail is inserted in the connector, stress is applied to the connection point between the touch sensor and the connector tail resulting from the distortion or deflection of the connector tail, which may lead to a critical defect such as the separation of the connection point.

An object of the present invention is to provide a novel and useful touch sensor, touch panel, and electronic device for solving the foregoing problem.

To solve the foregoing problem, for example, an aspect of the present invention is a touch sensor including: a sensor unit; and a connector tail having a first end portion connected to the sensor unit and a second end portion connected to a connector formed on a control substrate disposed on the back side of the sensor unit, wherein the second end portion of the connector tail includes a correction portion inclined according to an inclination angle formed by the sensor unit and the control substrate.

As the positional relationship between the sensor unit and the control substrate, the sensor unit may curve relative to the control substrate, or the sensor unit may incline relative to the control substrate.

The sensor unit may have a curved shape, and the correction portion may be formed such that, when the connector tail with the first end portion connected to the sensor unit is folded, the front end of the second end portion and an insertion opening of the connector are opposed to and approximately parallel to each other.

The sensor unit may have flexibility and may be entirely curved. Another aspect of the present invention may be a touch panel that includes the touch sensor of the aspect of the present invention and an external member holding the touch sensor.

Another aspect of the present invention may be an electronic device including the touch panel of the aspect of the present invention.

According to at least one aspect of the present invention, the correction portion is formed at the connector tail in correspondence with the relative positional relationship between the sensor unit and the control substrate, and it is possible to connect naturally the connector tail to the connector without applying an excessive load. The contents of the present invention are not interpreted in a limited sense by the advantageous effect described herein.

### BRIEF DESCRIPTION OF DRAWINGS

FIG. 1 is a partially exploded perspective view illustrating a configuration example of a touch panel according to an embodiment of the present invention;

FIG. 2 is a diagram for describing an example of attachment of a touch sensor to an external member according to the embodiment of the present invention;

FIG. 3 is a diagram illustrating a connector tail according to the embodiment of the present invention;

FIG. 4A is a diagram for describing a correction portion formed at the connector tail according to the embodiment of the present invention;

FIG. 4B is a diagram for describing a correction portion formed at the connector tail according to the embodiment of the present invention;

FIG. 4C is a diagram for describing a correction portion formed at the connector tail according to the embodiment of the present invention; and

FIG. 5 is a diagram for describing a modification example.

### DESCRIPTION OF EMBODIMENTS

An embodiment and the like of the present invention will be described below with reference to the drawings. The descriptions will be given in the following order:

### 1. Embodiment

### 2. Modification Example

The embodiment and the like described below are intended to exemplify a configuration for embodying the technical idea of the present invention but the present invention is not limited to the exemplified configuration. The members described in the claims are not limited to the members of the embodiment. In particular, unless otherwise specified, the descriptions of the dimensions, materials, shapes, relative positions, upper, lower, right and left sides of constituent members of the embodiment are not intended to limit the scope of the present invention but are merely explanatory examples. The sizes of the members and the positional relationships among them may be exaggerated in the drawings for purposes of clear illustration. In addition, only some of the reference signs may be shown in the drawings for prevention of complexity. In the following descriptions, the same designations and reference signs will refer to the same or equivalent members, and overlapped explanation will be omitted as appropriate. Of the respective elements of the present invention, a plurality of elements may be formed by one and the same member such that the member serves as the plurality of elements, or the function of one member may be divided among a plurality of members.

### 1. Embodiment

### [Schematic Configuration Example of a Touch Panel]

A touch panel to which a touch sensor according to an embodiment of the present invention is applied (touch panel 1) will be described as an example. The touch panel 1 is used as an input device for various electronics such as mobile terminals, cellular phones, and car navigation systems. For example, the touch panel of the embodiment is a capacitive touch panel that has a large number of electrodes disposed along an input operation area on an insulated substrate, detects an electrode with a change in capacitance between detection electrodes due to the approach of an input operation body such as a finger, and determines the input operation position from the position of the electrode, but is not limited to this.

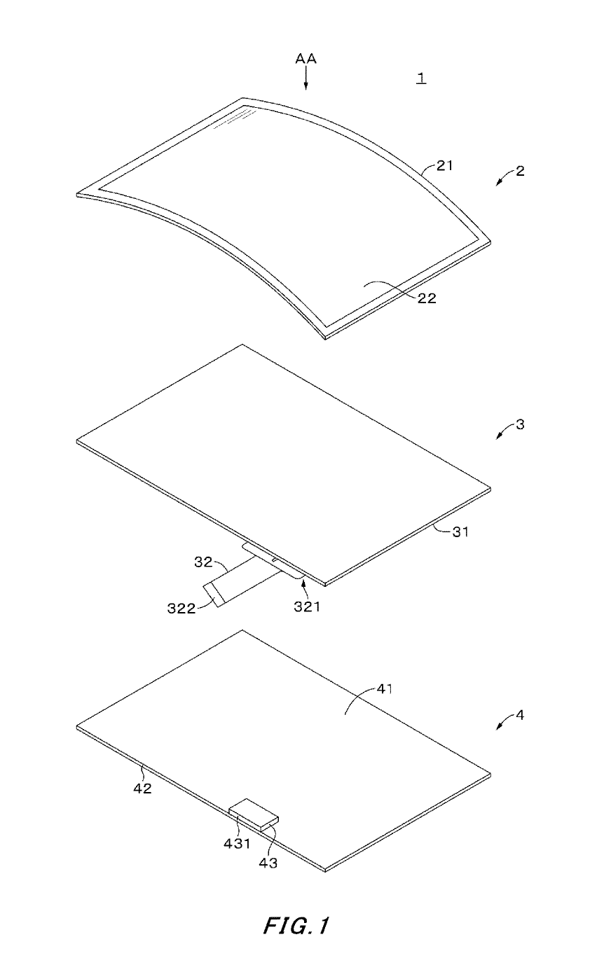

FIG. 1 is a partially exploded perspective view of the touch panel 1. The touch panel 1 is configured such that an external member 2, a touch sensor 3, and a wiring substrate 4 as an example of a control substrate are arranged on a front side (upper side in FIG. 1) in this order along a direction with respect to an input operation direction AA of the touch panel 1. The touch panel 1 has a display unit of liquid crystal, organic electro luminescence (EL), or the like between the touch sensor 3 and the wiring substrate 4, for example, but FIG. 1 and others do not illustrate it.

The external member 2 has a frame-like insulation case 21 made of resin, plastic, or the like. The inside of the opening (frame) of the insulation case 21 is set as an area capable of operation input into the touch panel 1. A protective cover 22 made of a transparent plastic material or film of acryl or ABS is provided in the inside of the opening of the insulation case 21. In this manner, the external member 2 is configured such that the insulation case 21 and the protective cover 22 are integrated. The external member 2 has a slightly convex-curved shape as a whole formed by curving longitudinally a rectangular plate in an arc taking designability into consideration. The external member 2 may be formed by molding integrally the parts for the insulation case 21 and the protective cover 22 from a transparent plastic material and then making prints on the part for the insulation case 21.

The touch sensor 3 has a sensor unit 31 and a connector tail 32 with one end attached to the peripheral edge of the sensor unit 31 in a predetermined position. The touch sensor 3 is curved in the same manner as the external member 2 and is held by the external member 2. For example, the external member 2 may have two curved plates that sandwich the touch sensor 3, or the touch sensor 3 is bonded to the back surface of the external member 2 by an adhesive tape or a bonding layer such as an adhesive layer.

The sensor unit 31 has flexibility and is deformable in an arbitrary shape. Although not illustrated in detail, the sensor unit 31 has a bonded structure in which transparent electrode patterns are formed in X and Y directions on two base materials and the two base materials are bonded together. The transparent electrode patterns may be ITO (Indium Tin Oxide) films. Lead patterns as transparent silver patterns are printed on the electrodes. The base materials may be glass sheets or films as an example.

The connector tail 32 is configured such that a copper-foil wiring pattern is formed on an insulating tail base material such as polyimide or polyethylene terephthalate (PET), and a tail protective sheet material covers the tail base material. The connector tail 32 is generally thin plate-like as a whole and has flexibility enough to be folded.

The connector tail 32 has first and second end portions 321 and 322. The first end portion 321 has a connection pattern (not illustrated) with a wiring pattern exposed. When the first end portion 321 is thermally compressed and bonded with lead patterns derived from the electrodes of the sensor unit 31 via an anisotropic conductive film, the sensor unit 31 and the connector tail 32 are electrically connected together. FIG. 1 illustrates the state in which the first end portion 321 is connected to the sensor unit 31. The second end portion 322 is connected to an FPC connector formed on the wiring substrate 4. The detailed shape of the connector tail 32 will be described later.

The wiring substrate 4 has a thin plate-like shape and is configured such that a conductive copper foil is patterned on a base material such as a glass epoxy material. An FPC connector 43 is formed (mounted) on the upper surface (front surface) 41 of the wiring substrate 4 at a place near a side surface (peripheral edge) 42. The FPC connector 43 has an insertion opening 431 via which the second end portion 322 of the connector tail 32 is inserted into the FPC connector 43.

Although not illustrated, the wiring substrate 4 has therein an arithmetic operation unit that processes a signal obtained by the touch sensor 3 and supplied via the connector tail 32 to detect the operation input position, a display controller that controls display on the display unit (or a one-chip IC (integrated circuit) controller having the same function), an interface with a processing device executing a control according to the operation input positon, and others.

### [Example of Attachment of the Touch Sensor]

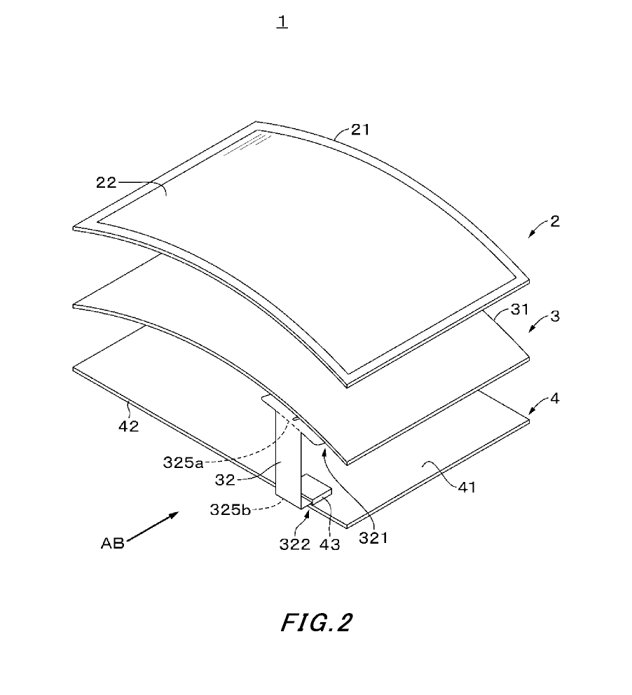

Next, an example of attachment of the touch sensor 3 to the external member 2 will be described with respect to FIG. 2. In this example, the first end portion 321 of the connector tail 32 is connected in advance to the sensor unit 31 of the touch sensor 3. The first end portion 321 is connected to a portion other than the apexes of the sensor unit 31 curved in an arc, for example.

The sensor unit 31 is attached to the back surface of the external member 2 by an appropriate method along the curved shape of the external member 2. When being attached to the external member 2, the sensor unit 31 curves in accordance with the shape of the external member 2. For the sake of easy understanding, FIG. 2 illustrates the external member 2 and the sensor unit 31 separated from each other.

When the sensor unit 31 curves, the connector tail 32 connected to the peripheral edge of the sensor unit 31 also curves accordingly. The curved connector tail 32 is folded at a first folding portion 325a such that the connector tail 32 extends downward (toward the back side). Then, the connector tail 32 is folded at a second folding portion 325b such that the second end portion 322 of the connector tail 32 is directed toward the wiring substrate 4, and then the second end portion 322 of the connector tail 32 is inserted into the FPC connector 43.

As described above, depending on the relative positional relationship between the sensor unit 31 and the wiring substrate 4, it may be difficult to insert naturally the second end portion 322 into the FPC connector 43. As in the embodiment, for example, while the sensor unit 31 and the wiring substrate 4 are arranged on the front and back (upper and lower) sides along a virtual arrangement axis, when the two are not approximately parallel to each other, more specifically, when the sensor unit 31 curves relative to the wiring substrate 4, the front end of the second end portion 322 inclines. Due to this inclination, it becomes difficult to arrange the front end of the second end portion 322 and the insertion opening 431 of the FPC connector 43 in approximately parallel to each other. Accordingly, it becomes difficult to insert naturally the second end portion 322 into the insertion opening 431. When the connector tail 32 is inserted into the FPC connector 43 in this situation, stress is applied to the connection point between the sensor unit 31 and the connector tail 32 due to the unnatural distortion or deflection of the connector tail 32, which may lead to a defect such as the separation of the connection point. Further, when the second end portion 322 is forcibly inserted, the connector tail 32 may become broken.

As an expected technique, by adjusting as appropriate the orientation of the insertion opening 431 of the FPC connector 43, this problem can be solved. According to this method, however, it is necessary to adjust the orientation of the insertion opening 431 in advance. Further, the orientation of the FPC connector 43 is limited to put restrictions on the arrangement (layout) of other electronic components to be mounted on the wiring substrate 4. In view of these respects, in the embodiment of the present invention, a correction portion is formed at the second end portion 322 of the connector tail 32. The correction portion formed at the second end portion 322 of the connector tail 32 and others will be described below in detail.

### [Example of Shape of the Connector Tail]

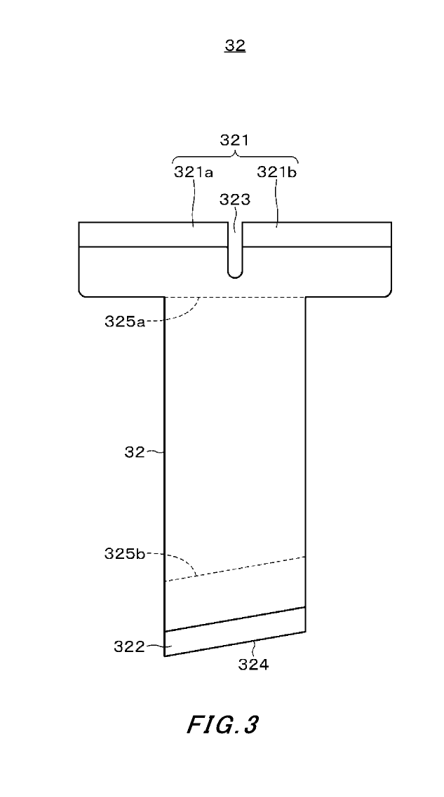

FIG. 3 is a diagram illustrating an example of shape of the connector tail 32. The first end portion 321 of an embodiment has a slit 323 near the middle. The slit 323 divides the first end portion 321 into end portions 321a and 321b. For example, the one end portion 321a is connected to the lead pattern of the transparent electrode pattern in the X-axis direction, and the other end portion 321b is connected to the lead pattern of the transparent electrode pattern in the Y-axis direction.

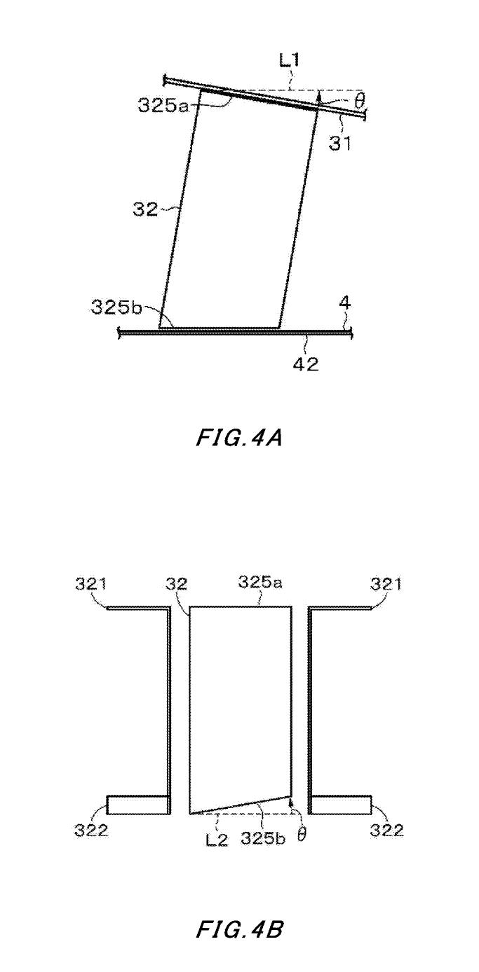

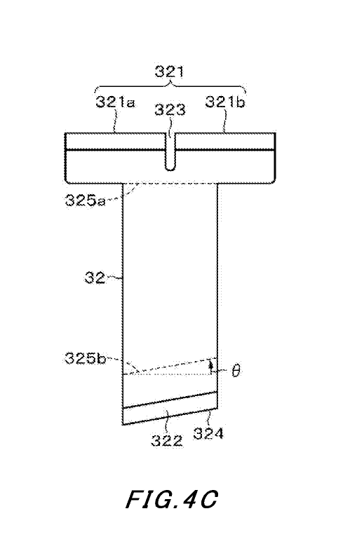

The second end portion 322 includes a correction portion 324 in correspondence with the relative positional relationship between the sensor unit 31 and the wiring substrate 4. The correction portion 324 will be described specifically with reference to FIGS. 4A to 4C.

FIG. 4A is an enlarged view of the connection point between the touch sensor 3 and the wiring substrate 4 by the connector tail 32, specifically, is a view of FIG. 2 from AB direction (lateral side). The entirely curved sensor unit 31 can be regarded as an inclined plane when the portion connected to the first end portion 321 is locally seen.

Line L1 as a dotted line in FIG. 4A is a virtual line approximately parallel to the wiring substrate 4. In the embodiment, the line L1 passes through the connection point of the first end portion 321 of the sensor unit 31 on the apex side. An inclination angle θ is produced between the line Ll and the other connection point of the first end portion 321 of the sensor unit 31 in accordance with the inclined plane of the sensor unit 31. Since the thickness of the sensor unit 31 is very small enough to be ignored, the angle formed between the first folding portion 325a and the line L1 can be regarded as inclination angle θ.

As described above, in the embodiment, the correction portion 324 is formed at the second end portion 322 of the connector tail 32. For the sake of easy understanding, descriptions will be given with the first folding portion 325a placed horizontally. FIG. 4B illustrates the connector tail 32 rotated counterclockwise by the inclination angle θ (front view, right view, and left view). Line L2 as a dotted line in FIG. 4B is a virtual line corresponding to the wiring substrate 4. As the result of the rotation, the same angle as the inclination angle θ is formed between the line L2 and the second folding portion 325b.

FIG. 4C is a development view of the connector tail 32 in which the first and second end portions 321 and 322 appear. As illustrated in the drawing, the correction portion 324 of the embodiment is inclined in approximately parallel to the second folding portion 325b. In other words, the correction portion 324 is inclined at the inclination angle θ formed by the sensor unit 31 and the wiring substrate 4. By forming the correction portion 324 at the front end of the second end portion 322, it is possible to obtain the state in which the front end of the second end portion 322 and the insertion opening 431 of the FPC connector 43 are opposed to and approximately parallel to each other even when the first end portion 321 is connected to the curved (locally inclined) sensor unit 31. Accordingly, it is possible to insert naturally the second end portion 322 into the FPC connector 43 of the wiring substrate 4 without making an unnatural bend or applying an excessive load. In addition, it is not necessary to adjust the orientation of the insertion opening 411 of the FPC connector 43 and the like before installing the FPC connector 41, thereby preventing the layout of the electronic components on the wiring substrate 4 from being restricted.

### 2. Modification Example

The embodiment of the present invention has been specifically described so far. However, the present invention is not limited to the foregoing embodiment but can be modified in various manners.

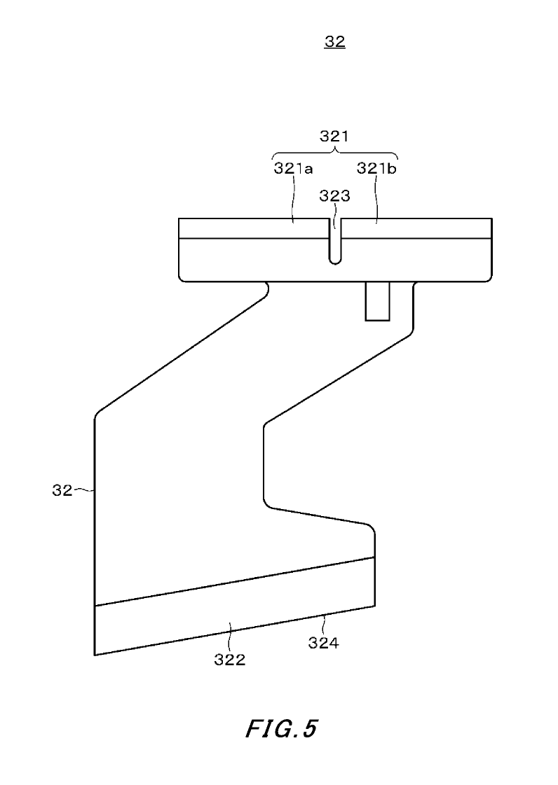

The shape of the connector tail 32 is not limited to the one described above in relation to the embodiment. For example, as illustrated in FIG. 5, part of the connector tail 32 may be bent in a plan view. By shaping the connector tail 32 in this manner, it is possible to handle the case in which the FPC connector 43 is positioned with a shift from the position immediately under the attachment place of the first end portion 321. The present invention is also applicable to the case in which the connector tail 32 shaped as illustrated in FIG. 5 is folded at a locally curved place (for example, a place extending downward from the first end portion 321).

In the embodiment described above, as the relative positional relationship between the sensor unit 31 and the wiring substrate 4, the sensor unit 31 curves relative to the wiring substrate 4 as an example. However, the relative positional relationship is not limited to this but the sensor unit 31 may lean (incline) relative to the wiring substrate 4.

In the foregoing embodiment, the entire sensor unit 31 curves. Alternatively, part (at least the peripheral edge) of the sensor unit 31 may curve. The sensor unit 31 may not necessarily have flexibility but the entire sensor unit 31 or at least its peripheral edge may curve independently. In this case, the sensor unit 31 includes two base materials curving in an independent manner. In addition, the sensor unit 31 may not have a bonding structure but may have a single-sided lamination structure in which transparent electrode patterns in the X and Y directions are formed on the single side of one base material. A predetermined electronic component such as a controller IC may be mounted on the connector tail 32 (also called chip-on-film).

The attachment process may be changed as appropriate such that the connector tail 32 is connected in advance to the FPC connector 43, and the touch sensor 3 and the wiring substrate 4 are integrated and attached to the external member 2.

The FPC connector 43 may be formed on the lower surface (back surface) of the wiring substrate 4, and the FPC connector 43 can be formed in an appropriate position.

In the foregoing embodiment, the entire external member 2 curves. Alternatively, part of the external member 2 may curve and the present invention is also applicable to this case. In addition, the external member 2 may be decorated as appropriate according to the use application of the touch panel 1. The protective cover 22 has light permeability to make visible the contents appearing on the display unit. The protective cover 22 may not be provided.

The external member 2, the touch sensor 3, and the display unit may be cylindrical in shape. The wiring substrate 4 may be disposed near the center of the cylindrical member. The present invention is also applicable to touch sensors and others for use in cylindrical displays or other displays of arbitrary shape.

In the embodiment described above, the folding state of the connector tail 32 is determined as the state in which the connector tail 32 is folded at the first and second folding portions 325a and 325b as an example. However, the folding matter of the connector tail 32 can be set as appropriate according to its shape. The term “approximately parallel” herein refers to the parallel state or a state slightly shifted from the parallel state as far as the advantageous effect of the present invention is produced (not harmed).

The configurations, methods, processes, shapes, materials, and numeric values described above in relation to the embodiment and the modification example are mere examples, and any other configurations, methods, processes, shapes, materials, and numeric values may be used as necessary or may be replaced with publicly known ones. The configurations, methods, processes, shapes, materials, and numeric values of the embodiment and the modification example can be combined together unless any technical conflict occurs.

Further, the present invention is not limited to a touch panel but can be carried out in any mode such as electronic devices including touch sensors and touch panels.

### REFERENCE SIGNS LIST

1 Touch panel
3 Touch sensor
4 Flexible wiring substrate
31 Sensor unit
32 Connector tail
321 First connection part
322 Second connection part
324 Correction portion
43 FPC connector
431 Insertion opening

1. A touch sensor comprising:
a sensor unit; and
a connector tail having a first end portion connected to the sensor unit and a second end portion connected to a connector formed on a control substrate disposed on the back side of the sensor unit, wherein
the second end portion of the connector tail includes a correction portion inclined according to an inclination angle formed by the sensor unit and the control substrate.

2. The touch sensor according to claim 1, wherein
as the positional relationship between the sensor unit and the control substrate, the sensor unit curves relative to the control substrate, or the sensor unit inclines relative to the control substrate.

3. The touch sensor according to claim 1, wherein
the sensor unit has a curved shape, and
the correction portion is formed such that, when the connector tail with the first end portion connected to the sensor unit is folded, the front end of the second end portion and an insertion opening of the connector are opposed to and approximately parallel to each other.

4. The touch sensor according to claim 1, wherein the sensor unit has flexibility and is entirely curved.

5. A touch panel comprising:
the touch sensor according to claim 1; and
an external member holding the touch sensor.

6. An electronic device comprising the touch panel according to claim 5.
